(19) United States
(12) Patent Application Publication
(10) Pub. No.: US 2002/0190782 A1
(43) Pub. Date: Dec. 19, 2002

(54) Circuit with source follower output stage and adaptive current mirror bias

(76) Inventors: Thomas A. Somerville, Tempe, AZ (US); Praveen V. Nadimpalli, Tempe, AZ (US)

Correspondence Address: OPPENHEIMER WOLFF & DONNELLY, P. O. BOX 10356, PALO ALTO, CA, 94303, US

(21) Appl. No.: 09/881,596

(22) Filed: Jun. 14, 2001

(51) Int. Cl. G05F 1/10

(52) U.S. Cl. 327/540

(57) ABSTRACT

The present invention provides a circuit that includes a source follower transistor that is driven by a signal mirror, sense transistor, and an output mirror. This circuit has improved performance due to the source follower transistor, the sense transistor and the output mirror, these items forming a common source difference amplifier. This common source difference amplifier adjusts the common voltage of the signal mirror to equalize the signal mirror input and output voltage. Thus, the common node of the mirror where voltage may be measured adapts to changing supply voltage, output load current and temperature so that the effect on source follower output voltage is minimized. For optimum performance, the current density ratio of the output mirror devices is equal to the current density ratio of the sense transistor to the source follower transistor.

### CROSS-REFERENCE TO RELATED APPLICATIONS

Not applicable.

### STATEMENT REGARDING FEDERALLY SPONSORED RESEARCH

Not applicable.

### FIELD OF THE INVENTION

The present invention relates generally to current mirror circuits, and more particularly to a source follower output stage that bootstraps the output impedance of the mirror driving it so that changes in input supply voltage and load current have substantially less effect on the output voltage.

### BACKGROUND OF THE INVENTION

“Bootstrapping” is a term of art in electronics, and is used to increase the output impedance of a mirror, thereby increasing open loop gain and providing more closed loop accuracy as well as improved power supply rejection ratio. Bootstrapping is commonly accomplished by driving a common circuit node with an emitter or source follower so that the common circuit node voltage maintains a constant relationship to an output of the circuit. Bootstrapping also commonly requires additional supply current to bias the follower circuit.

Current mirrors are commonly used in operational amplifier circuit design so that a single reference current may be used to generate additional currents referenced to each other throughout the circuit. A current mirror circuit may generally include a configuration such as a transistor, having its base and collector short-circuited, and connected at two points to a second transistor. The connection between the first transistor and the second transistor is base-to-base and emitter-to-emitter.

In U.S. Pat. No. 5,592,123 (“the '123 patent”) issued to Ulbrich on Jan. 7, 1997, disclosed is a floating current mirror circuit for achieving high open loop gain without additional voltage gain stages. According to Ulbrich's disclosure, this invention avoids additional frequency compensation and increased power dissipation. FIGS. 1A and 1B are illustrations of the invention described in the '123 patent. Referring now to FIG. 1A, disclosed is a current mirror bootstrap for increasing the output impedance of the mirror by driving the common node V.sub.e of the mirror with emitter follower Q.sub.3. By increasing the output impedance of a current mirror at the output of an amplifier stage, the open loop gain is increased thereby providing more closed loop accuracy as well as an improved power supply rejection ratio. The uncorrected bootstrap error is the difference in collector-emitter voltage of Q.sub.1 and Q.sub.2 that form the current mirror. This voltage is also V.sub.b3-V.sub.b1.

There is a need for a circuit that provides improved reference output circuit accuracy at a low supply voltage. There is also a need for a circuit that provides stable capacitive load drive capability at low supply or quiescent current. There is also a need for a circuit that provides greater bootstrap accuracy without increasing the total power dissipation of the circuit.

### SUMMARY OF THE INVENTION

The present invention solves the needs addressed above. The present invention provides a circuit that includes a signal mirror, a source follower output transistor, a sense transistor, and an output mirror. This circuit has improved performance due to the source follower transistor, the sense transistor and the output mirror, these items forming a common source difference amplifier. This common source difference amplifier adjusts the common voltage of the signal mirror to keep equal voltages at two points in the circuit. Thus, the common node of the mirror adapts to changing supply voltage, output load current and temperature so that the effect on output voltage is minimized. For optimum performance, the current density ratio of the output mirror devices is equal to the current density ratio of the sense transistor to the source follower transistor.

The present invention uses a source follower output stage which is not used in the prior art. This source follower output stage provides advantages over the prior art, including lower output impedance to minimize output voltage change with changing load current as well as improved stability driving capacitive loads. Capacitive load drive capability is proportional to the grounded source follower gate capacitance.

The prior art also does not include connecting two mirrors as in the present invention. The present invention uses an output mirror to bootstrap the signal mirror. This configuration provides benefits over the prior art in that the output mirror current is proportional to load current for high efficiency. When the load current is small, the output mirror current is low. An additional benefit resulting from this configuration is that the minimum supply voltage necessary to provide a given output voltage is minimized since a current source provides load current from supply to output.

It is an object of the invention to provide improved circuit performance by boosting the output impedance of a current mirror so that changes in input supply voltage and load current have substantially less effect on output voltage.

It is also an object of the present invention to provide bootstrap accuracy without requiring a higher quiescent current.

It is further an object of the present invention to provide a circuit for use with varying output loads and capacitive loads.

The benefits of the present invention make the invention very useful in a number of applications. Those applications include battery-powered applications where as few batteries as possible are desired. Portable electronics, including CD players and cellular phones, would be benefited by aspects of the present invention.

### BRIEF DESCRIPTION OF THE DRAWINGS

These and other objects, features, and characteristics of the present invention will become apparent to one skilled in the art from a close study of the following detailed description in conjunction with the accompanying drawings and appended claims, all of which form a part of this application. In the drawings:

FIG. 1A is a schematic circuit diagram for a bootstrapped current mirror circuit in accordance with the prior art;

FIG. 1B is an alternate embodiment of a schematic circuit diagram for a bootstrapped current mirror circuit in accordance with a prior art patent;

FIG. 2 is a schematic circuit diagram of a source follower output stage with adaptive current mirror bias in accordance with one embodiment of the present invention;

FIG. 3A is a schematic circuit diagram of a source follower output stage with adaptive current mirror bias including an NPN implementation of one current mirror and an NMOS implementation of the other current mirror in accordance with another embodiment of the present invention; and

FIG. 3B is a schematic circuit diagram of a source follower output stage with adaptive current mirror bias including an NPN implementation of one current mirror, an NMOS implementation of the other current mirror and a regulated current source implementation of one current source in accordance with yet another embodiment of the present invention.

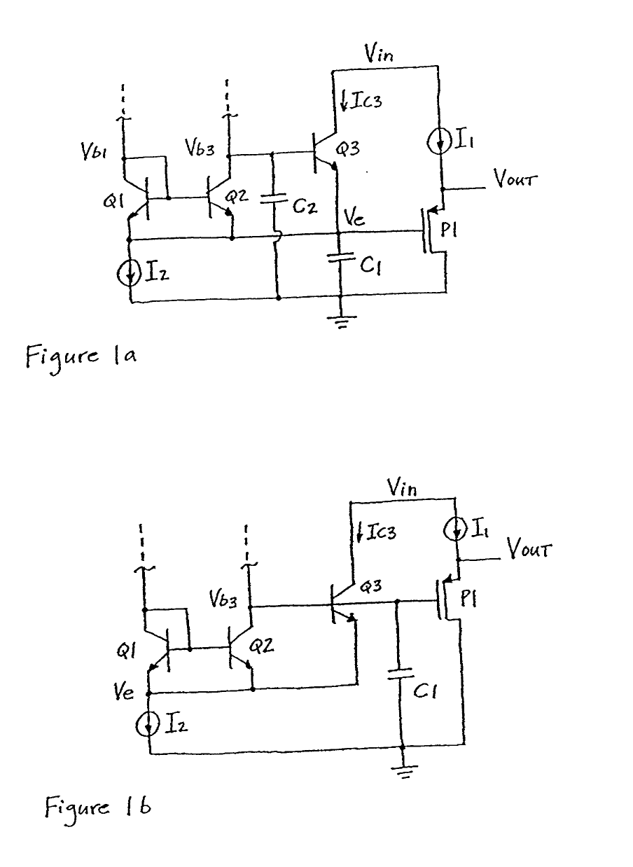

### DETAILED DESCRIPTION OF THE PRESENTLY PREFERRED EXEMPLARY EMBODIMENTS

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds, are therefore intended to be embraced by the appended claims.

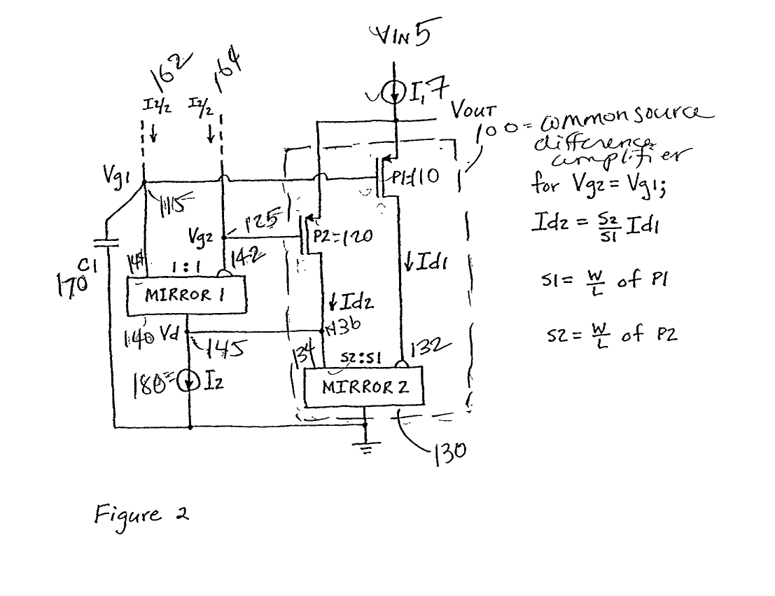

Disclosed is a circuit that is especially useful for applications for which the output voltage must be precise. Referring now to FIG. 2, illustrated is a source follower output stage with adaptive current mirror bias in accordance with one embodiment of the present invention. Configurations such as bandgap voltage reference circuits can act as inputs to this common source difference amplifier shown in FIG. 2. Shown in FIG. 2 is an input supply voltage 5 and a source current 7. A common-source difference amplifier 100 is formed by source follower transistor (P1) 110, sense transistor (P2) 120, and an output mirror 130. A signal mirror 140 is also provided. The source follower transistor (P1) 110 is differential to sense transistor 120, signal mirror 140 and output mirror 130. Source follower transistor (P1) 110 and sense transistor (P2) are input transistors with the same current density. Sense transistor (P2) provides input into the amplifier that allows for a balanced position. Output mirror 130 has input 132 and output 134. Signal mirror 140 has input 142 and output 144.

The common source (or emitter) difference amplifier inputs are the input and output voltage of mirror 140. The input 142 of mirror 140 can be represented by V.sub.g2 125, while the output 144 of mirror 140 can be represented by V.sub.g1 115. A node 136 is common to the mirror 140, sense transistor 120 and V.sub.d 145. The common source difference amplifier adjusts the common voltage V.sub.d 145 of mirror 140 to keep V.sub.g2 at reference node 125 equal to V.sub.g1 at reference node 115. This adjustment is commonly known as “bootstrapping”. This bootstrap effect boosts the output impedance of mirror 140 so that changes in supply voltage and load current have substantially less effect on the output voltage. This adjustment adapts the common node of mirror 140 to changing supply voltage, output load current and temperature so that the effect on output voltage is minimized. The ratio of device W/L in the mirror 130 is equal to W/L ratio of the sense transistor 120 to source follower transistor 110 for optimum performance. The width to length ratio (W/L) of source follower transistor (P1) 110 may be equal to the width to length ratio (W/L) of sense transistor (P2) 120, thereby making the drain currents of those devices equal as represented by the formula: I.sub.d2=(S.sub.2/S.sub.1)*I.sub.d1, where S.sub.1 is the width to length ratio of the source follower transistor and S.sub.2 is the width to length ratio of the sense transistor.

The current source I.sub.2 is provided equal to the sum of signal mirror currents 162, 164 for optimum performance. Typically, a difference amplifier or folded cascode provides the I.sub.2/2 currents from the supply to the signal mirror.

The uncorrected error of the common source difference amplifier is V.sub.ce2−V.sub.ce1=V.sub.g1−V.sub.g2. This error is proportional to 1/gm of the source follower transistor and the sense transistor. The transconductance of the source follower transistor 110 can be shown as:

g.sub.m1=sqrt[2*Id1*μ*Cox*S1]

where I.sub.d1 is the drain current of the source follower transistor 110, μ is the mobility of the holes in the induced P-channel, Cox is the gate capacitance, and S.sub.1 is the width to length ratio of source follower transistor 110.

Source follower transistor 110 has a gate, source and drain. The gate of source follower transistor 110 is coupled to node 115 which is the high impedance output voltage of the signal mirror. Node 115 is, in turn, operably coupled to compensation capacitor 170 for frequency stabilization. Capacitor 170 is also coupled to ground. Sense transistor 120 has a gate, source and drain. The gate of sense transistor 120 is coupled to node 125 which is the input voltage of the signal mirror.

This arrangement is more efficient than the emitter follower bootstrap and only requires one compensation capacitor 150 for frequency stability.

The output voltage is determined by circuitry not shown. Such circuitry may comprise a bandgap voltage reference input stage. The input currents shown in FIG. 2 are represented by I.sub.2/2 as shown to the upper left of the circuit. A feedback loop may also be provided by coupling the output voltage to the input stage with a resistive voltage divider. The feedback circuitry may take a variety of forms.

As sinking load current increases, the bootstrap accuracy increases without requiring a higher quiescent current. Also, the width to length ratio (W/L) of source follower transistor 110 may be greater than width to length ratio (W/L) of sense transistor 120 to improve current efficiency. For example, a low power reference may include an output stage with current I.sub.2 less than one micro-amp while the sinking load current might be greater than one hundred micro-amps. Using this improved adaptive bias technology, the current load regulation is greatly improved.

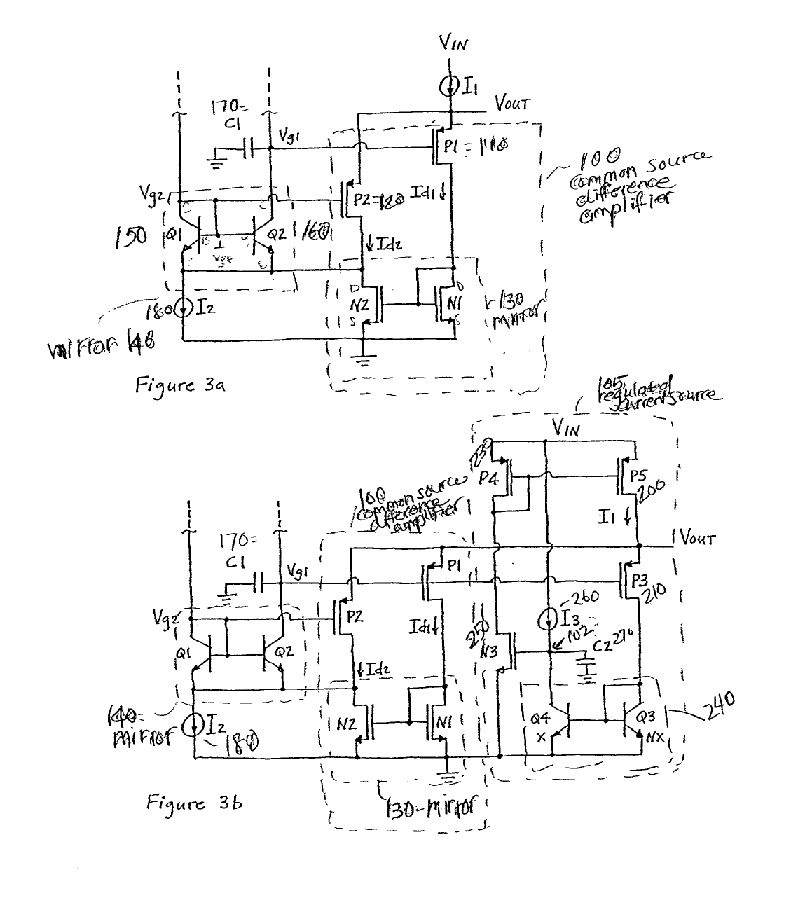

Referring now to FIG. 3A, illustrated is a schematic circuit diagram of a source follower output stage with adaptive current mirror bias including an NPN implementation of one current mirror and an NMOS implementation of the other current mirror in accordance with another embodiment of the present invention. The mirror 140 is an NPN implementation in this embodiment. Mirror 140 is a floating mirror circuit, meaning the emitters are coupled not to a ground but to a node at a different potential or to a node coupled to the ground by a current source. Mirror 140 is composed of a first NPN transistor 150 and a second NPN transistor 160. Transistors 150, 160 include a base, emitter and collector region. The base of transistor 150 is coupled to the base of transistor 160, and the emitter of transistor 150 is coupled to the emitter of transistor 160. Since the bases and emitters are coupled together, the transistors have the same base-to-emitter voltages. Transistor 150 is also connected as a diode by shorting its collector to its base. The input current I.sub.2/2 flows through the diode connected transistor and thus establishes a voltage across transistor 150 that corresponds to the value of the current of I.sub.2/2. As long as transistor 160 is maintained in the active region, its collector current I.sub.2/2 will be approximately equal to I.sub.2/2.

This mirror circuit uses all NPN transistors to overcome undesirable limited frequency responses of similar circuits employing PNP differential input transistors.

Like the circuit illustrated in FIG. 2, the uncorrected error of the common source difference amplifier is V.sub.ce2−V.sub.ce1=V.sub.g1−V.sub.g2. This error is proportional to 1/gm of the source follower transistor and the sense transistor. The transconductance of the source follower transistor 110 can be shown as:

g.sub.m1=sqrt[2*Id1*μ*Cox*S1]

where Id1 is the drain current of the source follower transistor 110, μ is the mobility of the holes, Cox is the gate capacitance, and S1 is the width to length ratio of source follower transistor 110.

In FIG. 3A, the sum of the drain currents for source follower transistor 110 and sense transistor 120 (I.sub.d1 and I.sub.d2, respectively) are equal to the sinking load current. Referring now to FIG. 3B, disclosed is the circuit shown in FIG. 3A, but using a regulated current source 105. The regulated current source includes a first PMOS transistor 200 and a second PMOS transistor 230. The gate of said first PMOS transistor is operably coupled to the gate of the second PMOS transistor. A third PMOS transistor 210 operably coupled to the first PMOS transistor 200. The gate of the third PMOS transistor 210 is coupled to the gate of source follower transistor 110. The regulated current source also includes a current mirror circuit 240; the current mirror circuit is operably coupled to the third PMOS transistor 210. A node 102 is common to an NMOS transistor 250, a bias current 260 and a second compensation capacitor 270. The NMOS transistor is operably coupled to the second PMOS transistor 230. The compensation capacitor is also coupled to ground.

Like the circuits shown in FIGS. 2 and 3A, the uncorrected error of the common source difference amplifier is V.sub.ce2−V.sub.ce1=V.sub.g1−V.sub.g2. This error is proportional to 1/gm of the source follower transistor and the sense transistor. The transconductance of the source follower transistor can be shown as:

g.sub.m1=sqrt[2*Id1*μ*Cox*S1]

where I.sub.d1 is the drain current of the source follower transistor 110, μ is the mobility of the holes, Cox is the gate capacitance, and S.sub.1 is the width to length ratio of source follower transistor 110.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A source follower output stage circuit with adaptive current mirror bias, comprising:
a common source difference amplifier device including a source follower transistor device, an output mirror circuit device, a sense transistor device, and a first current source device, wherein said source follower transistor device, said output mirror circuit device and said sense transistor device are operably coupled to each other, wherein said source follower transistor has a first voltage that is measured at a first voltage node and said sense transistor has a second voltage that is measured at a second voltage node;
a second mirror circuit device, wherein the second voltage is input into the second mirror circuit device and the first voltage is output from the second mirror circuit device;
a first node common to the second mirror circuit device, the sense transistor, and the output of the output mirror circuit device, wherein said first node has a common voltage;
an input device for inputting two input currents, wherein one of said input currents is input at said first voltage node, and the second input current is input at said second voltage node;
a second current load at said first node;
such that the common source difference amplifier device adjusts said common voltage such that the first voltage of the source follower transistor is equal to the second voltage of the sense transistor and the effect on the source follower output voltage is minimized with variations in supply voltage, temperature and output load current.

2. The circuit of claim 1 wherein the width to length ratio of the sense transistor is equal to the width to length ratio of the source follower transistor, such that the drain currents of said sense transistor and said source follower transistor are equal to each other.

3. The circuit of claim 1 wherein the width to length ratio of the source follower transistor is proportional to the width to length ratio of the sense transistor, such that the drain currents of said sense transistor and said source follower transistor are proportional to each other.

4. The circuit of claim 1 wherein the output mirror circuit device includes NMOS transistors.

5. The circuit of claim 1 wherein the output mirror circuit device includes two NMOS transistors and the gates and sources of said two NMOS transistors are coupled together and the drain of one of said NMOS transistors is connected to the gates of said two NMOS transistors while the drain of the other NMOS transistor is the mirror output.

6. The circuit of claim 1 wherein the second mirror circuit is an NPN current mirror circuit.

7. The circuit of claim 6 wherein the NPN current mirror circuit includes two NPN transistors, wherein the base of the first NPN transistor is coupled to the base of the second NPN transistor, and the collector of the second of said NPN transistors is connected to the bases of said two NPN transistors.

8. The circuit of claim 1 wherein the width to length ratio of the source follower transistor is greater than the width to length ratio of the sense transistor.

9. The circuit of claim 1 wherein
the output voltage of said common source difference amplifier is measured at the differential pair common point for said amplifier.

10. The circuit of claim 1 further comprising:
a first compensation capacitor device for providing frequency stability, wherein said first compensation capacitor device is coupled to the first voltage node and also to ground.

11. The circuit of claim 1 wherein
said first source current device is regulated such that the current of the common source difference amplifier is minimized and independent of current provided to a load at the output.

12. The circuit of claim 1 wherein the first current source device is a regulated current source device.

13. The circuit of claim 12 wherein the regulated current source device includes a first PMOS transistor, wherein said first PMOS transistor is configured with its drain coupled to its gate;
a second PMOS transistor, wherein the gate of said first PMOS transistor is operably coupled to the gate of the second PMOS transistor;
a third PMOS transistor operably coupled to the second PMOS transistor, said third PMOS transistor having its gate coupled to the gate of said source follower transistor;
a current mirror circuit, wherein said current mirror circuit is operably coupled to the third PMOS transistor;
a current source node, said current source node being common to an NMOS transistor, a source current and a second compensation capacitor; wherein said NMOS transistor is operably coupled to the first PMOS transistor; and
wherein said second compensation capacitor is coupled to ground.

14. The circuit of claim 1 further comprising:
a feedback circuit device for controlling the two input currents.

15. A source follower output stage circuit with adaptive current mirror bias, comprising:
a source follower transistor, an output mirror circuit, a sense transistor, and a first current source, wherein said source follower transistor, said output mirror circuit and said sense transistor are operably coupled to each other, wherein said source follower transistor has a first voltage that is measured at a first voltage node and said sense transistor has a second voltage that is measured at a second voltage node;
a second mirror circuit, wherein the second voltage is input into the second mirror circuit and the first voltage is output from the second mirror circuit;
a first node common to the second mirror circuit, the sense transistor, and the output of the output mirror circuit, wherein said first node has a common voltage;
a circuit for inputting two input currents, wherein one of said input currents is input at said first voltage node, and the second input current is input at said second voltage node;
a second current load at said first node;
such that the common source difference amplifier adjusts said common voltage such that the first voltage of the source follower transistor is equal to the second voltage of the sense transistor and the effect on the source follower output voltage is minimized with variations in supply voltage, temperature and output load current.

16. The circuit of claim 15 wherein the width to length ratio of the sense transistor is equal to the width to length ratio of the source follower transistor, such that the drain currents of said sense transistor and said source follower transistor are equal to each other.

17. The circuit of claim 15 wherein the width to length ratio of the source follower transistor is proportional to the width to length ratio of the sense transistor, such that the drain currents of said sense transistor and said source follower transistor are proportional to each other.

18. The circuit of claim 15 wherein the output mirror circuit includes NMOS transistors.

19. The circuit of claim 18 wherein the output mirror circuit includes two NMOS transistors and the gates and sources of said two NMOS transistors are coupled together, and the drain of one of said NMOS transistors is connected to the gates of said two NMOS transistors, while the drain of the other NMOS transistor is the mirror output.

20. The circuit of claim 15 wherein the second mirror circuit is an NPN current mirror circuit.

21. The circuit of claim 20 wherein the NPN current mirror circuit includes two NPN transistors, wherein the base of the first NPN transistor is coupled to the base of the second NPN transistor, and the collector of the second of said NPN transistors is connected to the bases of said two NPN transistors.

22. The circuit of claim 15 wherein the width to length ratio of the source follower transistor is greater than the width to length ratio of the sense transistor.

23. The circuit of claim 15 wherein
the output voltage of said common source difference amplifier is measured at the differential pair common point for said amplifier.

24. The circuit of claim 15 further comprising:
a first compensation capacitor for providing frequency stability, wherein said first compensation capacitor is coupled to the first voltage node and also to ground.

25. The circuit of claim 15 wherein
said first source current is regulated such that the current of the common source difference amplifier is minimized and independent of current provided to a load at the output.

26. The circuit of claim 15 wherein the first current source is a regulated current source.

27. The circuit of claim 26 wherein the regulated current source includes a first PMOS transistor, wherein said first PMOS transistor is configured with its drain coupled to its gate;
a second PMOS transistor, wherein the gate of said first PMOS transistor is operably coupled to the gate of the second PMOS transistor;
a third PMOS transistor operably coupled to the second PMOS transistor, said third PMOS transistor having its gate coupled to the gate of said source follower transistor;
a current mirror circuit, wherein said current mirror circuit is operably coupled to the third PMOS transistor;
a current source node, said current source node being common to an NMOS transistor, a source current and a second compensation capacitor; wherein said NMOS transistor is operably coupled to the first PMOS transistor; and
wherein said second compensation capacitor is coupled to ground.

28. The circuit of claim 15, further comprising:
a feedback circuit for controlling the two input currents.
